(19) United States
(12) Patent Application Publication
(10) Pub. No.: US 2013/0307919 A1
(43) Pub. Date: Nov. 21, 2013

(54) MULTIPLE CAMERA VIDEO CONFERENCING METHODS AND APPARATUS

(71) Applicant: Brown University, Providence, RI (US)

(72) Inventor: Gabriel Taubin, Providence, RI (US)

(73) Assignee: Brown University, Providence, RI (US)

(21) Appl. No.: 13/870,616

(22) Filed: Apr. 25, 2013

Related U.S. Application Data
(60) Provisional application No. 61/638,717, filed on Apr. 26, 2012.

(51) Int. Cl. H04N 7/15

(52) U.S. Cl. CPC H04N 7/15
USPC 348/14.02; 348/14.08

(57) ABSTRACT

In some aspects, a multi-camera device to facilitate multiple camera video conferencing is provided. The multi-camera device comprises a plurality of input ports, each configured to receive video information when connected to a respective external video camera, an output port configured to output video information, and a selection component coupled to the plurality of input ports and the output port, the selection component configured to provide video information received by at least one of the input ports to the output port for output to an external computer.

### REFERENCE TO RELATED APPLICATION(S)

The present application claims the benefit under 35 U.S.C. §119(e) of U.S. Provisional Application Ser. No. 61/638,717, filed on Apr. 26, 2012, titled “Multi-Camera Video Conferencing Switch,” which is hereby incorporated by reference in its entirety.

### BACKGROUND

Conventional video conferencing equipment allows video obtained from one location to be transmitted to a remote location via one or more computer networks and/or vice versa. Conventionally, a single camera captures video of a location and a computer coupled to the camera transfers the video to the remote location for viewing. As such, in video conferencing circumstances including multiple participants in a given location, the single video feed of the location, when rendered, may be confusing, unclear or otherwise not especially useful to viewers at the remote location. For example, a camera positioned and configured to capture all participants in its field of view may result in video in which the participants are relatively difficult to view in meaningful detail. Alternatively, a more limited field of view may leave some participants off-camera. Moreover, it may be difficult to ascertain who is speaking from a single video feed capturing multiple participants, such that the conversation may be difficult to follow and interaction between participants at the different locations awkward and/or, at times, incomprehensible. Furthermore, conventional video conferencing equipment is typically very costly, requiring expensive hardware and software to implement the system.

As an alternative to such relatively expensive and complicated video conferencing equipment, internet-based video conferencing software (e.g., Skype, WebEx, or AdobeConnect) has been developed to exploit relatively inexpensive video cameras, such as Universal Serial Bus (USB) WebCams with embedded microphones, or integrated video cameras that now come standard with many laptop computers. Captured video may be transmitted via one or more networks to which the personal computer can connect and video captured at a remote location can be similarly received to achieve video conferencing. Such solutions, while cheaper, conventionally still suffer from the same drawbacks of having a single camera such that the clumsiness and difficulty of trying to achieve video conferencing with multiple participants at a given location may not be worth the effort given the poor results. Solutions that have tried to address single camera problems require specialized software installed on a computer (and multiple video capable ports) to handle multiple video feeds coming from multiple cameras and are not viable general purpose solutions.

### SUMMARY

Some embodiments include a multi-camera device to facilitate multiple camera video conferencing. The multi-camera device comprises a plurality of input ports, each configured to receive video information when connected to a respective external video camera, an output port configured to output video information, and a selection component coupled to the plurality of input ports and the output port, the selection component configured to provide video information received by at least one of the input ports to the output port for output to an external computer. According to some embodiments, the multi-camera device is configured to be plug-and-play operable with external video cameras connected at one or more of the plurality of input ports and an external computer connected to the output port.

### BRIEF DESCRIPTION OF DRAWINGS

Various aspects and embodiments of the application will be described with reference to the following figures.

FIG. 1 illustrates a multi-camera device, in accordance with some embodiments;

FIG. 2 illustrates a schematic of a multiple camera video conference having four participants in a given location, the video conference facilitated by the multi-camera device illustrated in FIG. 1;

FIG. 3 illustrates example presentations of audio/video produced by a multi-camera device in connection with the example video conference illustrated in FIG. 2, in accordance with some embodiments;

FIG. 4 illustrates example presentations of composite audio/video produced by a multi-camera device in connection with the example video conference illustrated in FIG. 2, in accordance with some embodiments;

FIGS. 5A and 5B illustrate further example presentations of composite audio/video produced by a multi-camera device in connection with the example video conference illustrated in FIG. 2, in accordance with some embodiments; and

FIG. 6 illustrates an exemplary computer system suitable for implementing techniques described herein.

### DETAILED DESCRIPTION

As discussed above, conventional video conferencing solutions have drawbacks associated with capturing a location having multiple participants using a single video camera. Multiple camera solutions that attempt to address one or more drawbacks associated with single camera video capture require specialized software and do not provide a general solution for multiple camera video conferencing. The inventors have recognized the benefit of a device that can enable multiple camera video conferencing, some embodiments of which can be implemented in a relatively simple and inexpensive manner and/or deployed as a general solution to video conferencing that may be particularly suited to circumstances in which one or both of the video conferencing locations include multiple participants.

Some embodiments include a multiple camera (multi-camera) device having a plurality of input ports, each configured to receive video information when connected to a respective external video camera, an output port capable of outputting video information, and a selection component configured to provide video information from at least one of the plurality of input ports to an output port for output to an external computer connected to the output port. According to some embodiments, the selection component identifies a target input port and provides the video information from at least the target input port to the output port for output to an external computer when connected.

According to some embodiments, the selection component produces composite video information from video information received from multiple input ports from the plurality of input ports. According to some embodiments, the composite video is produced by combining video information received at the target input port and video information received from at least one other of the plurality of input ports. According to some embodiments, no target input port is selected and composite video is produced by combining video information from input ports that are connected to an external video camera. The selection component may provide composite video information, however produced, to the output port for output to an external computer when the multi-camera device is connected to the external computer.

According to some embodiments, the selection component determines a target input port by analyzing audio information and/or video information from each of the plurality of input ports that are connected to a respective external video camera. For example, the selection component may analyze audio information from each input port connected to a camera to determine which input port is receiving the loudest audio (e.g., the greatest amplitude audio). In the context of a multiple participant video conference where a separate video camera is aimed at each participant and connected to respective input ports of the device, the input port at which the loudest audio is received may be indicative of which participant is currently speaking. The selection component may use this information to select the corresponding input port as the target input port.

The selection component may additionally, or in the alternative, analyze video information received from each of the input ports connected to a respective external video camera to detect activity. In the above multiple participant video conference, the selection component may identify the video information exhibiting the most significant motion and/or motion in key regions of the video information, and utilize this information as indication of which participant is currently speaking. For example, the selection component may process video information from connected input ports generally to detect and evaluate motion to assess which participant is likely speaking and select the corresponding input port as the target input port. According to some embodiments, the selection component may analyze video information to detect regions of the video information corresponding to human faces and detect motion in these regions (e.g., regions corresponding to the lips) to facilitate identifying a current speaker. The selection component may use this information to select the corresponding input port as the target input port. The selection component may be configured to monitor audio information and/or video information to track the participant that is currently speaking and select the corresponding input port as the target input port.

As discussed above, the selection component may provide audio information and/or video information received at the current target input port to the output port for output to an external computer. As discussed above, the target input port may be selected by analyzing the audio information and/or video information received at input ports that are connected to an external video camera. According to some embodiments, the target input port may be selected by a user (e.g., a participant in a video conference) by actuating one or more manually actuated components provided by the multi-camera device. According to some embodiments, the selection component provides just the audio information and video information received at the target input port to the output port for output to an external computer, when connected. In this manner, the selection component operates generally as a switch that can be caused to switch between the input ports connected to respective external video cameras and/or as a smart switch that selects a target input port based on processing the received audio and/or video information so as to provide at the output port the audio/video information of the participant that is believed to be currently speaking.

According to some embodiments, the selection component combines video information received at multiple input ports, e.g., video information received at the target input port with video from at least one other input port to form composite video information. The composite video information may be provided to the output port for output to an external computer, when connected. In this manner, composite video provided at the output may include video of multiple participants. In embodiments in which a target input port is determined or selected, composite video provided at the output may include video of multiple participants (e.g., each participant at a location) with the currently speaking participant emphasized, for example, by formatting the composite video such that, when rendered, video information from the target input port is presented in a larger spatial region, portion or location of the composite video and video information from other input ports is presented in smaller spatial regions, portions or locations. According to some embodiments, audio information from the target input port alone is provided to the output port to facilitate the current speaker being heard clearly. In other embodiments, audio information from multiple ports and/or each input port contributing to the composite video is combined (potentially with different gains) and provided to the output port. Many different presentations within the composite video are possible, some examples of which are discussed in further detail below.

The inventors have appreciated that a single video stream may be provided to the output port, which may include video information from a single input port (e.g., an automatically determined or manually selected target input port) or composite video information from multiple input ports. To the external computer, the video information at the output port of the device may appear like video from a single camera. Accordingly, whatever video conferencing software that may be installed on an external computer (e.g., Skype, WebEx, or AdobeConnect, etc.) may be used with the device without modification to the software or external computer to thereby achieve multi-camera video conferencing. That is, the multi-camera device may format the audio/video information provided at the output so that existing drivers and/or installed software on an external computer will treat the video information from the device as if it came from a single camera according to the format or standard expected by the external computer. As such, audio/video information from multiple cameras, either as video from a single camera that changes as the speaker changes or as composite video information displaying multiple participants may be transmitted to a remote location via one or more networks to which the external computer is connected.

Following below are more detailed descriptions of various concepts related to, and embodiments of, methods and apparatus for facilitating multiple camera video conferencing. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

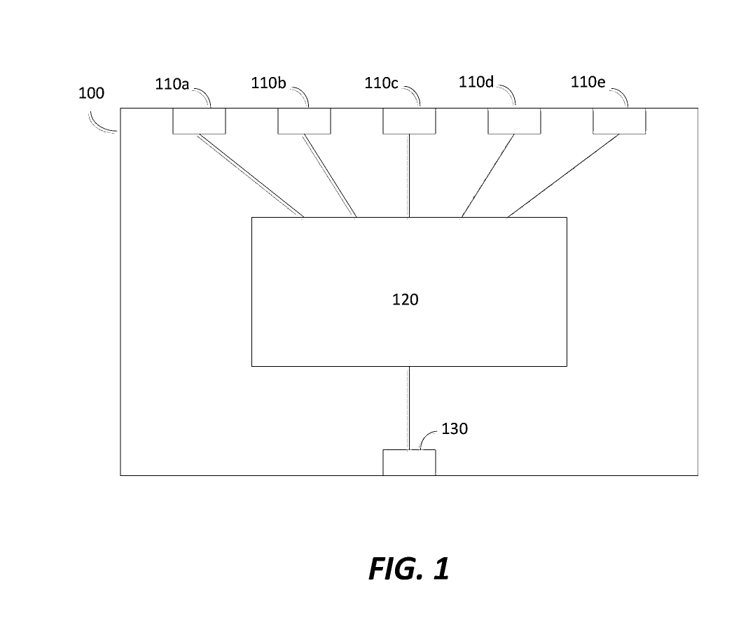

FIG. 1 illustrates a multi-camera device that facilitates video conferencing using a plurality of video cameras at a location having multiple participants, in accordance with some embodiments. Multi-camera device 100 comprises a plurality of input ports 110a-110e, referred to collectively as input ports 110, capable of receiving audio information and/or video information (denoted herein as audio/video information to mean audio information, video information, or both) when connected to respective external video cameras, output port 130 configured to output audio/video information, and a selection component 120 coupled to input ports 110 to provide audio/video information from at least one of the input ports to the output port 130 for output to, for example, an external computer capable of connecting to multi-camera device 100.

According to some embodiments, multi-camera device 100 is designed to be useable with standard digital video cameras, for example, any variety of webcam, internet protocol (IP) camera, or other video camera generally designed for plug-and-play connectivity with a computer system. For example, input ports 110 may include any one or combination of USB compatible input port(s), IEEE 1394 (FireWire) compatible input port(s), GigE Vision compatible input port(s), Camera Link compatible input port(s), wireless compatible input ports (e.g., IEEE 802.11, infrared, etc.), and/or input port(s) compatible with any other digital communication standard capable of exchanging audio information and/or video information.

According to some embodiments, multi-camera device 100 includes one or more input ports configured to communicate with a respective external video camera in a plug-and-play manner such that standard digital video cameras (e.g., off-the-shelf webcams, video cameras integrated in a smart phone, etc.) can be connected to multi-camera device 100 and be operational without or with limited specific customization or special installation procedures. As such, according to some embodiments, multi-camera device 100 may be configured to operate with one or any combination of webcams, IP cameras, Camera Link video cameras, etc., when connected to one or more of the above described external video cameras. The term “connected” refers herein to the state of being communicatively coupled and includes both wired and wireless connections. While multi-camera device 100 is shown having five input ports, it should be appreciated the number of input ports illustrated in FIG. 1 is merely exemplary and multi-camera device 100 may include any number or type of input ports, as the aspects are not limited in this respect. That is, different embodiments of a multi-camera device 100 may be provided in any desired configuration with respect to the number and type of input ports provided for connection to respective external video cameras.

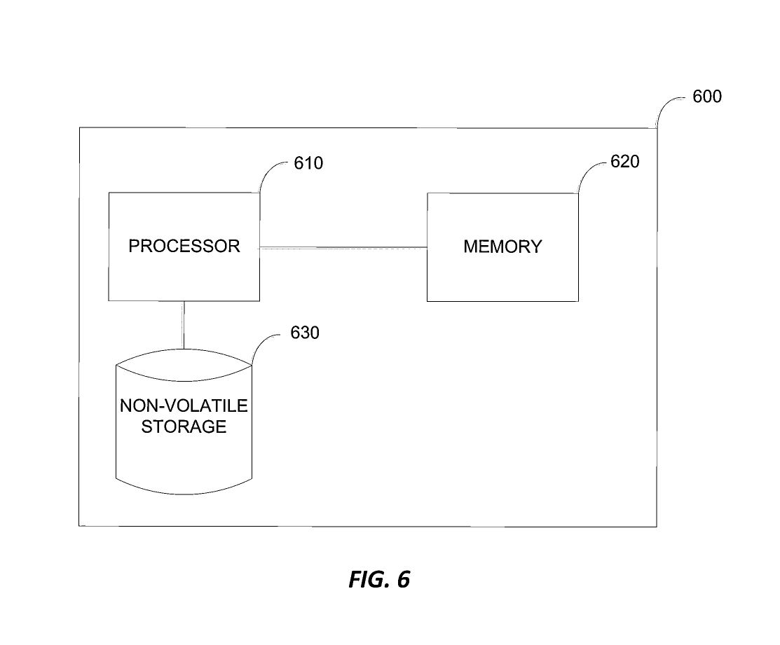

As discussed above, multi-camera device 100 includes a selection component 120 coupled to the input ports 110 to receive video information from the input ports when the respective input port is connected to an external video camera and to provide audio/video information from at least one of the input ports to output port 130 for output to, for example, an external computer connected to one or more networks and hosting video teleconferencing software such that at least some of the audio/video received from multi-camera device 100 may be transmitted to a remote location. Selection component 120 may be implemented in hardware, software, firmware or any combination thereof. For example, selection component may be implemented, at least in part, by a processor such as a digital signal processor capable of executing software instructions stored in a computer readable storage medium such as a memory, as discussed in further detail in connection with FIG. 6. Selection component 120 may be configured to perform selection, processing and/or analysis of received audio/video information to achieve various multiple camera video conferencing functionality, some examples of which are described in further detail below.

As discussed above, multi-camera device 100 also includes output port 130 to receive audio/video information from selection component 120 for output when connected to an external computer. Output port 130 may be any output port suitable for outputting audio/video information and may include one or multiple output ports of any type. In particular, output port 130 may include any of the port types described above in connection with input ports 110. For example, output port 130 may include a USB port such that multi-camera device 100 can be connected to any external computer having a USB port to exchange audio/video information. Alternatively, or in addition to, output port 130 may include FireWire compatible output port(s), GigE Vision compatible output port(s), Camera Link compatible output port(s), wireless compatible output ports (e.g., WiFi, infrared, etc.), and/or output port(s) compatible with any other digital communication standard capable of exchanging audio information and/or video information. To simplify the illustration of multi-camera device 100, output port 130 is used to represent any number and type of output port provided on multi-camera device 100 and may include one or multiple output ports. Accordingly, output port 130 may include a single output port of a particular type, or may include multiple output ports of the same or different types such that different configurations allow for connection to one or more external computer(s) having different connection types to facilitate multiple camera video conferencing in a wide variety of circumstances.

It should be appreciated that there need not be parity between the input ports 110 and output port 130 in either number or type. In particular, the input and output ports may include any number and type of ports, which may be the same or different. As such, selection component 120 may be configured to convert audio/video information from the format/standard received at an input port to a different format/standard of the desired output port as needed. Thus, multi-camera device 100 may be configured to be useable with a wide variety of available computer equipment (video cameras, computer systems, etc.). For example, multi-camera device 100 may include a FireWire input port and a USB output port so that the device can be utilized in a situation where a FireWire video camera is available, but the external computer to be connected to the output of multi-camera device 100 includes a USB port, or a multi-camera device may include a plurality of USB input ports and a USB output port. In this manner, some embodiments of multi-camera device 100 may not only facilitate multiple camera video conferencing, but may provide adapter capabilities as well.

It should be appreciated that selection component 120 may be as simple as a hardware and/or software solution that switches between video streams received from the input ports, or may include functionality to process the video streams from the input ports, analyze which input port is “active” (e.g., which video stream includes activity such as a speaking participant), form composite video, convert between different formats/standards, and/or perform any other desired functionality, as the aspects are not limited to any particular set of functionality. Accordingly, multi-camera device 100 may be implemented at any level of desired complexity to produce an apparatus that facilitates general purpose multiple camera video conferencing suitable for a wide variety of video conferencing needs, from simple to complex, some examples of which are described in further detail below.

As discussed above, selection component 120 may be configured to determine a target input port from the plurality of input ports 110 and provide audio/video information at least from the target input port to the output port 130. Selection component 120 may be configured to determine the target input port in any number of different ways. According to some embodiments, selection component 120 is caused to select one of the plurality of input ports 110 as the target input port by a manually actuated component, for example, provided on multi-camera device 100. In particular, multi-camera device 100 may include a button, switch, dial or other component that can be manually actuated to select one of the input ports as the target input port.

For example, multi-camera device 100 may include a button that toggles to the next input port when pressed so that each time the button is pressed, the selection component 120 selects the next input port as the target input port. Alternatively, each input port may include an associated button that can be pressed to select the corresponding input port as the target input port, a dial may be provided that allows a user to turn the dial to select one of the input ports as the target input port, a slide, switch or other mechanism may be provided to allow a user to cause selection component 120 to select a desired input port as the target input port from which audio/video information is provided to the output port. It should be appreciated that any manually actuated component capable of indicating one or more of the input ports may be used, as embodiments that employ such a feature are not limited for use with any particular type of component.

According to some embodiments, selection component 120 is configured to automatically determine the target input part based, at least in part, on audio information and/or video information received from the input ports. For example, selection component 120 may be configured to select the target input port based on activity detected at the corresponding port. According to some embodiments, selection component 120 may monitor audio information received at the input ports to evaluate which port is receiving the loudest audio. In the context of a video conference, the input port over which the loudest audio is being received provides an indication as to which participant is speaking at a given moment in time. As a result, the selection component may choose the input port at which the greatest magnitude audio is being received as the target input port, and the audio/video information received over the target input port may be provided to output port 130, alone or in combination with other audio/video information received at the input ports.

Selection component 120 may also be configured to determine the target input port based on video information received from the input ports. For example, selection component 120 may process video information received from the input ports to detect motion in the corresponding video information. Motion in a video feed received from an input port may indicate that the corresponding participant is speaking and/or gesturing. Numerous techniques are known to detect and evaluate motion in video, any of which may be used to detect and/or characterize motion in video information received from the input ports. According to some embodiments, video information received from the input ports is processed to identify regions in the video corresponding to human faces. Such techniques are conventionally used in cameras to locate faces for the purposes of auto-focusing, or for other computer vision purposes. Any of the numerous techniques for detecting and locating human faces may be used to detect a region of video information received from the input ports corresponding to human faces.

Motion detection techniques may then be localized to the regions determined to include a human face. Thus, having localized motion detection, detected motion may more likely indicate a speaking participant and may reduce instances in which motion in a particular video feed not associated with a speaking participant (e.g., a non-speaking participant shifting position or other motion in the video feed) causes the selection component 120 to erroneously select the corresponding input port as the target input port. It should be appreciated that any other computer vision or video processing technique may be used to detect activity or otherwise determine that video information received from a particular input port should be selected as the target input port. According to some embodiments, selection component 120 may utilize both audio and video information from the input ports to determine the target input port. It should be appreciated that the above described techniques are merely exemplary and any technique or combination of techniques for manually or automatically selecting or determining a target input port may be used, as the aspects are not limited in this respect.

When a target input port has been selected, audio/video information may be provided to the output port 130 for output to an external computer connected to the output port 130. The audio/video information from the target input port may be provided to the output port 130 alone or combined with audio/video information from other input ports to produce composite audio/video information, some examples of which are described in further detail below. According to some embodiments, selection component 120 does not determine or select a target input port. Instead, the selection component 120 combines audio/video information from each input port having an external video camera connected and provides the composite audio/video information to the output port 130 for output to a connected external computer. In such embodiments, the selection component may tile or otherwise arrange the audio/video streams from connected input ports so that the composite audio/video information, when rendered, presents at least video from each of the connected input ports, some examples of which are also discussed in further detail below.

According to some embodiments, multi-camera device 100 may provide additional information with the audio/video information provided at output port 130. For example, multi-camera device may provide text, graphics, sound or any other media capable of being rendered such that when the audio/video information is presented, the additional media may also be presented such as via an overlay on the audio/video information. In this respect, multi-camera device 100 may include one or more auxiliary inputs capable of connecting to an external computer and/or connecting to one or more networks to obtain the additional media. Alternatively, or in addition to, multi-camera device may store additional media in internal storage or be configured to produce the additional media (e.g., via one or more programs stored on the multi-camera device) for provision along with the audio/video information. As a non-limiting example, multi-camera device may have access to information about the participants including names such that each participant's name (or other information such as title, location, etc.) may be displayed as text or a text graphic overlaid on the video information, or the name of the participant identified as currently speaking alone may be displayed. As another example, multi-camera device 100 may include speech recognition capabilities, or may be connected via a network to a speech recognition resource, such that audio may be recognized and a transcription provided, either by producing a text file that can be accessed subsequently, or by providing an overlay on the video such that the transcription appears on the video when rendered. When participants names are available, the corresponding name may be included in association with the transcription to identify which participant spoke the corresponding portion of the transcription. It should be appreciated that any other media may be used to emphasize, augment, annotate or overlay audio/video information provided by the multi-camera device, as aspects are not limited in this respect.

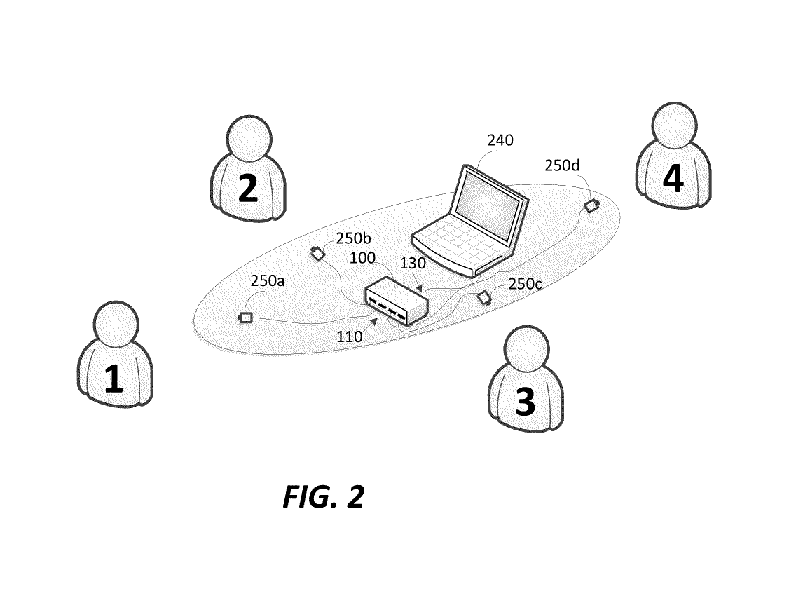

FIG. 2 illustrates a schematic of an exemplary video conference for which a multi-camera device may be utilized. In FIG. 2, four participants 1-4 are located at a location and are engaging in a video conference with a remote location. In particular, external computer 240 may be connected to one or more networks (e.g., via a wireless link to the Internet) and have installed video conferencing software configured to transmit audio/video information received at an input port of external computer 240 and transmit the audio/video information over the one or more networks to the remote location. External computer 240 may also render the received audio/video information on a display of the computer. External computer 240 may be any computer including, but not limited to, a standalone personal computer, a laptop, multiple networked computers, or any other computer capable of receiving audio/video information and transmitting the information over a network to a remote location.

The video conference depicted in FIG. 2 utilizes a multi-camera device 100, which may be similar to any of the embodiments described in connection with FIG. 1, and which is shown as a table-top appliance in the example illustrated in FIG. 2. Four video cameras (250a-250d) are connected to respective input ports 110 on multi-camera device 200 and are aimed at respective participants in the video conference. Video cameras 250a-250d may be any type or combination of types of digital video cameras capable of being connected to one of the input ports of the multi-camera device. For example, video cameras 250a-250d may include one or more webcams, one or more IP cameras, one or more Camera Link cameras, etc., and may include embedded microphones or may be coupled to respective microphones such that audio/video information is provided to respective input ports on the multi-camera device. Video cameras 250a-250d may be plug-and-play video cameras providing audio/video information according to a respective standard such that they can be connected and operational without requiring installation of proprietary software, drivers, etc.

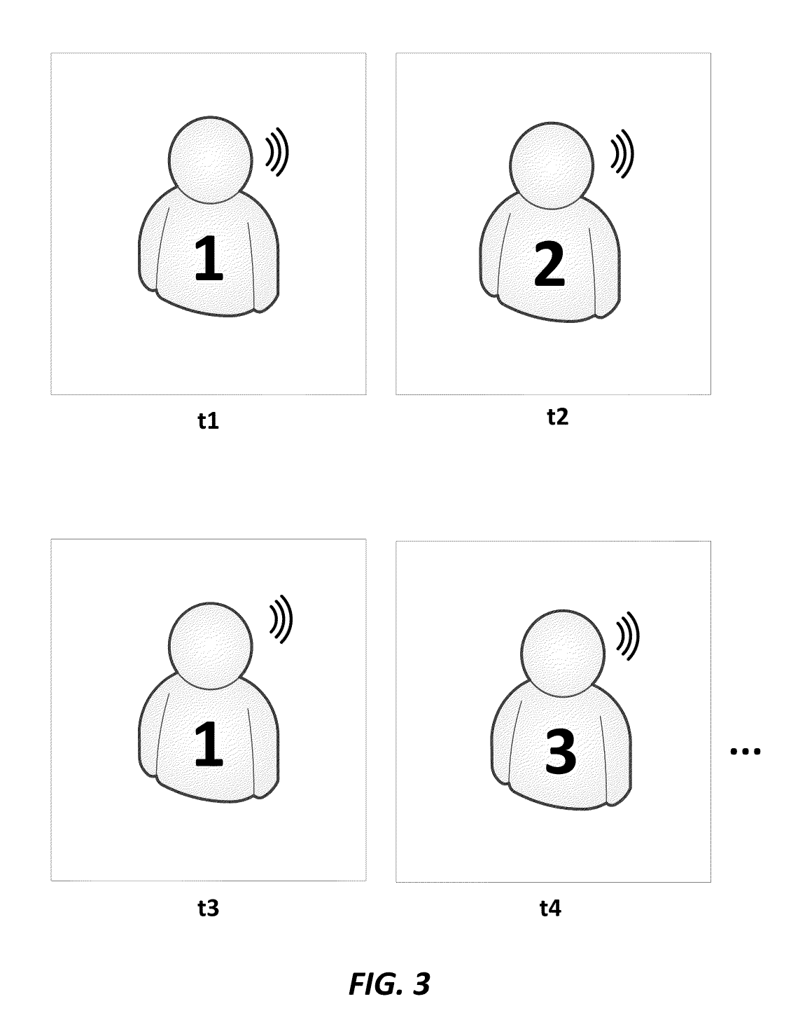

Multi-camera device 100 receives the audio/video information from the video cameras connected at the input ports and provides audio/video information from at least one of the input ports to an output port 130 at which the external computer 240 is connected (e.g., via a selection component of the multi-camera device). FIG. 3 illustrates a rendering of audio/video information provided at the output port of a multi-camera device 100, for example, as received in the example video conference illustrated in FIG. 2, according to some embodiments. To produce the presentation schematically depicted in FIG. 3, the multi-camera device is configured to detect which participant is speaking by analyzing the audio/video information received at the input ports to determine a target input port, which may be achieved using any of the techniques described herein. Audio/video information from the target input port is then provided to the output port for output to external computer 240.

In particular, FIG. 3 illustrates audio/video information rendered from the target input port at times t1, t2, t3 and t4 during the video conference involving participants 1-4 illustrated in FIG. 2. In particular, at time t1, participant 1 is speaking and multi-camera device selects the corresponding input port as the target input port. As such, audio/video information from the target port is provided at the output port such that, when rendered, participant 1 can be seen and heard. At a time t2, participant 2 is speaking and the multi-camera device detects the change in speaker and selects the corresponding input port as the target input port. As result, audio/video information from the new target port is provided at the output port such that, when rendered, participant 2 can be seen and heard. At a time t3, participant 1 begins speaking again and at a time t4, participant 3 is speaking. During the course of the conversation, multi-camera device 100 monitors the audio/video received at the input ports connected to a respective external video camera and selects as the target input port the input port connected to the external video camera aimed at a participant that is speaking. As such, the audio/video information output by the multi-camera device, when rendered, presents audio/video information corresponding to the speaking participant. It should be appreciated that the presentation illustrated in FIG. 3 could be achieved without detecting the speaker, for example, by selecting the target input port using one or more manually actuated components. For example, a participant can actuate one or more manually actuated components to select which audio/video information is provided to the output port for output to external computer 240.

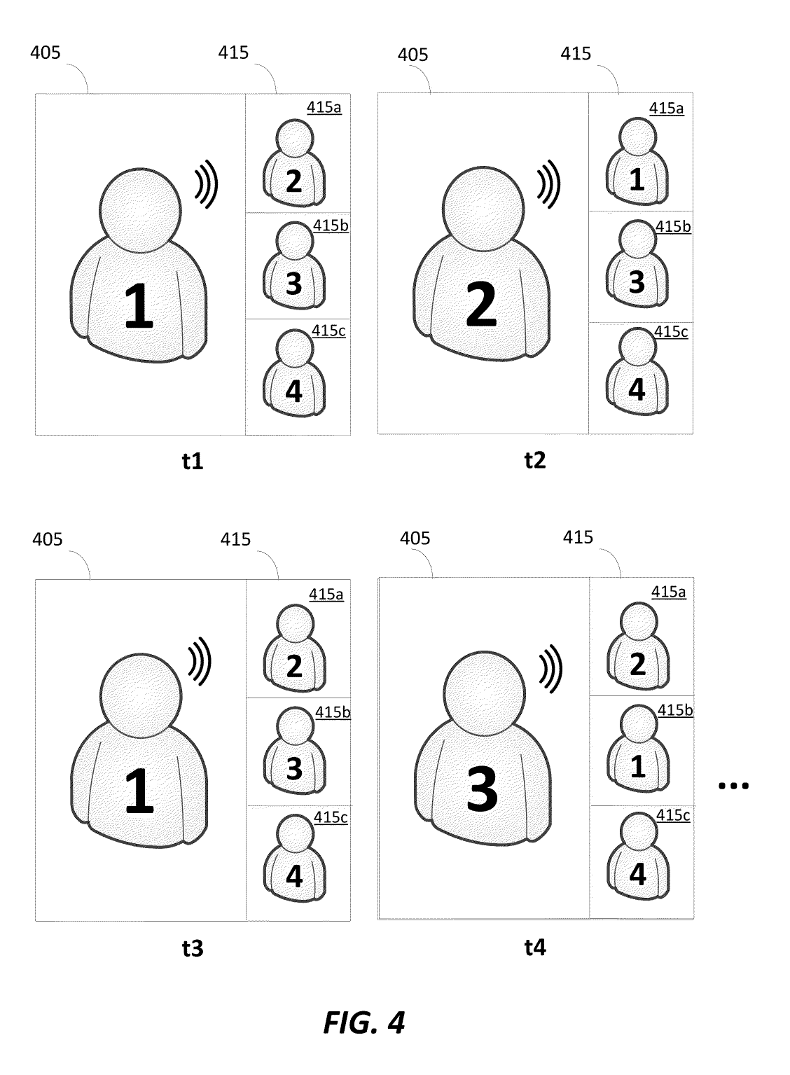

FIG. 4 illustrates a presentation of audio/video information received at input ports of multi-camera device 100 whereby the multi-camera device 100 produces composite audio/video information from audio/video information received at each input port connected to an external video camera, in accordance with some embodiments. FIG. 4 illustrates the same time sequence as FIG. 3. However, instead of presenting just the audio/video information from the target input port, the multi-camera device 100 combines audio/video information from the target input port with audio/video information received at other input ports having a connected video camera. In particular, audio/video information from the target input port, when rendered, is presented in a first spatial location 405 and video information from other input ports connected to a video camera, when rendered, are presented in a second spatial location 415 having sub-locations 415a, 415b and 415c for each connected input port, respectively.

As the speaker changes, the multi-camera device (e.g., via a selection component) selects a new corresponding target input port and combines the audio/video information from the target input port with video information from other input ports to produce composite audio/video information that, when rendered, presents audio/video information from multiple ports, for example, as illustrated in the exemplary presentations at times t1, t2 and t3 in FIG. 4. In the embodiment illustrated in FIG. 4, only audio received at the target input port is included in the composite audio/video information as denoted by the audio icon shown in connection with the rendering of the audio/video information from the target input port. However, it should be appreciated that audio from other input ports could alternatively be included in the composite audio/video information provided to the output port, as the aspects are not limited in this respect.

In the embodiment in FIG. 4, the first spatial location in which the audio/video information from the target input port is presented is larger than the second spatial location where video information from other input ports is presented. However, audio/video information from input ports connected to a respective video camera may be combined to produce composite audio/video information in any manner, as the aspects are not limited in this respect. It should be appreciated that the presentation illustrated in FIG. 4 could also be achieved without detecting the speaker, for example, by selecting the target input port using one or more manually actuated components. For example, a participant can actuate one or more manually actuated components to select which audio/video information is presented with the primary focus (e.g., video provided in a larger spatial location in rendered video and/or with the audio stream activated).

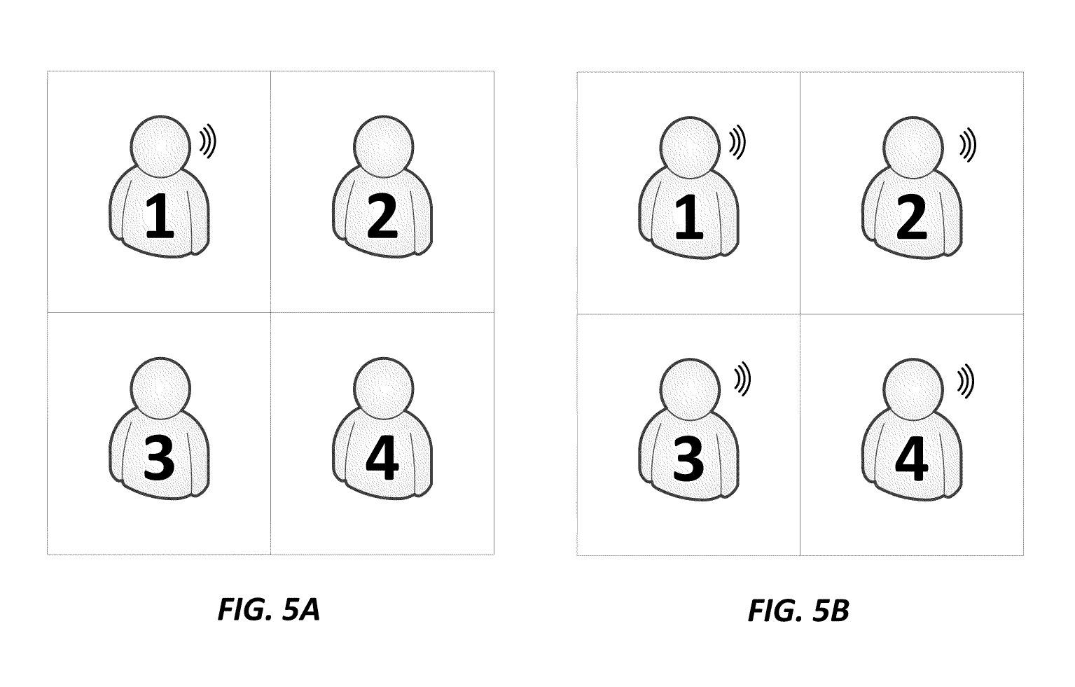

According to some embodiments, the multi-camera device does not detect or select a target input port. Instead, the multi-camera device (e.g., via a selection component) combines audio/video information from input ports connected to a respective video camera to produce composite audio/video information. For example, as illustrated in FIG. 5A, video information from each input port connected to an external camera is combined to form composite video information that is provided to the output port such that when the composite video is rendered, each participant is viewable in a tiled presentation. It should be appreciated that in such embodiments, no target input port need be detected or selected and any video received at the input ports can be included in the composite video to provide a multi-camera view of the participants of a video conference. In the embodiment illustrated in FIG. 5A, only audio information from one input port is included in the composite audio/video information for rendering (as denoted by the single audio icon), while in the embodiment illustrated in FIG. 5B, audio information from multiple input ports is provided in the composite for rendering. According to some embodiments, a multi-camera device includes a manually actuated component that allows a user to select from which input port or combination of input ports audio information should be included in the composite audio/video information provided at the output port for rendering.

According to some embodiments, a multi-camera device may be configured to operate in a first mode where a target input port is detected and a second mode wherein no target input is detected. In this manner, a user may be able to select a mode more appropriate for a given video conferencing circumstance. While selecting a target input port may facilitate a more comprehensible presentation, there may be circumstances wherein a mode in which no target input port is selected is preferable. For example, in a video conference in which multiple participants are speaking simultaneously, or speakers are changing rapidly, it may be preferable to select the mode illustrated in FIG. 5A or 5B to avoid a potentially confusing audio/video presentation. Furthermore, according to some embodiments, a multi-camera device can be selected to operate either by switching between audio/video information provided at a target input port, or to provide composite audio/video of the target input port and one or more other input ports at which an external video camera is connected.

An illustrative implementation of a computer system 600 that may be used to implement one or more components and/or techniques described herein is shown in FIG. 6. Computer system 600 may include one or more processors 610 and one or more non-transitory computer-readable storage media (e.g., memory 620 and one or more non-volatile storage media 630). The processor 610 may control writing data to and reading data from the memory 620 and the non-volatile storage device 630 in any suitable manner, as the aspects of the invention described herein are not limited in this respect. Processor 610, for example, may be a processor provided as part of an implementation of a multi-camera device. Computer system 600 need not include both memory 620 and non-volatile storage media 630.

To perform functionality and/or techniques described herein, the processor 610 may execute one or more instructions stored in one or more computer-readable storage media (e.g., the memory 620, storage media, etc.), which may serve as non-transitory computer-readable storage media storing instructions for execution by processor 610. Computer system 600 may also include any other processor, controller or control unit needed to route data, perform computations, perform I/O functionality, etc. For example, computer system 600 may include any number and type of input functionality to receive data and/or may include any number and type of output functionality to provide data, and may include control apparatus to perform I/O functionality.

In connection with receiving audio/video information, detecting/selecting a target input port, producing composite audio/video information and/or converting between different audio/video formats, etc., one or more programs configured to perform such functionality, or any other functionality and/or techniques described herein may be stored on one or more computer-readable storage media of computer system 600. In particular, some portions or all of a selection component may be implemented as instructions stored on one or more computer-readable storage media. Processor 610 may execute any one or combination of such programs that are available to the processor by being stored locally on computer system 600. Any other software, programs or instructions described herein may also be stored and executed by computer system 600. Computer system 600 may be implemented in any manner and may be connected to a network and capable of exchanging data in a wired or wireless capacity.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which multiple examples have been provided. The acts performed as part of each process may be ordered in any suitable way. Accordingly, embodiments may be constructed in which acts are performed in an order different than illustrated, which may include performing some acts concurrently, even though shown as sequential acts in illustrative embodiments.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. An device comprising:
a plurality of input ports, each configured to receive video information when connected to a respective external video camera;
an output port configured to output video information; and
a selection component coupled to the plurality of input ports and the output port, the selection component configured to provide video information received by at least one of the input ports to the output port for output to an external computer.

2. The device of claim 1, wherein the plurality of input ports are each configured to receive audio information when connected to a respective external video camera, and wherein the selection component is configured to provide audio information received by at least one of the input ports to the output port for output to an external computer when connected.

3. The device of claim 2, wherein the selection component is configured to select one of the plurality of input ports as a target input port.

4. The device of claim 3, wherein the selection component is configured to monitor the audio information and/or video information received at each of the plurality input ports to identify the target input port.

5. The device of claim 3, wherein the selection component is configured to monitor the audio information from each of the plurality of input ports to identify the target input port based on which of the plurality of input ports receives audio of greatest magnitude.

6. The device of claim 3, wherein the selection component is configured to monitor the video information received at each of the plurality of input ports to identify the target input port based on motion detected in the video information from the respective input port.

7. The device of claim 6, wherein the selection component is configured to detect regions in received video information corresponding to human faces, and wherein the selection component is configured to detect motion within the regions corresponding to the human faces to determine the target input port.

8. The device of claim 3, wherein the selection component is configured to provide the video information received at the target input port to the output port for output to the external computer when connected.

9. The device of claim 3, wherein the selection component is configured to combine video information received from the target port and video information received by at least one other of the plurality of input ports and provide composite video information derived therefrom to the output port for output to the external computer when connected.

10. The device of claim 9, wherein the composite video information is formatted such that, when the composite video information is rendered, video information received at the target port is presented at a first spatial portion of the composite video information and video information received at the at least one other of the plurality of input ports is presented at a second spatial portion of the composite video information.

11. The device of claim 10, wherein only audio information received from the target port is provided to the output port for output to the external computer when connected.

12. The device of claim 10, wherein the composite video information includes video information from each input port at which an external camera is connected, and wherein the second spatial portion includes a sub-portion corresponding to each of the at least one other of the plurality of input ports at which an external camera is connected, and wherein the first spatial portion of the composite video information comprises a larger spatial portion than each sub-portion.

13. The device of claim 3, wherein the selection component continually monitors the audio information and/or video information from each of the plurality of input ports and automatically determines which of the plurality of ports is the target input port based upon the audio information and/video information from each of the plurality of input ports.

14. The device of claim 3, further comprising a manually actuated component, wherein when the manually actuated component is actuated by a human operator, the selection component selects a next input port from the plurality of input ports as the target input port.

15. The device of claim 1, wherein the plurality of input ports include at least one Universal Serial Bus input port for connecting to an external Universal Serial Bus video camera.

16. The device of claim 1, wherein each of the plurality of input ports is configured to receive audio information and/or video information from a respective external video camera according to a digital audio and/or video standard, and the output port is configured to provide audio information and/or video information according to a digital audio and/or video standard.

17. The device of claim 16, wherein the plurality of input ports include a first input port configured to receive audio information and/or video information from a respective external video camera according to a first digital audio and/or video standard and a second input port configured to receive audio information and/or video information from a respective external video camera according to a second digital audio and/or video standard different than the first.

18. The device of claim 17, wherein the selection component is configured to convert audio information and/or video information between the first digital audio and/or video standard and the second audio and/or video standard prior to providing audio information and/or video information to the output port.

19. The device of claim 1, wherein the plurality of input ports and the output port are configured to be plug-and-play operable.

20. The device of claim 1, wherein the output port includes a Universal Serial Bus port to connect to a Universal Serial Bus port of an external computer.

21. The device of claim 1, wherein the plurality of input ports includes at least one wireless input port capable of connecting to an external video camera wirelessly.

22. The device of claim 1, wherein the output port includes at least one wireless output port capable of connecting to an external computer wirelessly.

23. The device of claim 1, wherein the plurality of input ports include at least one wired input port configured to connect to an external video camera via a wired connection and at least one wireless input port capable of connecting to an external video camera wirelessly.

24. The device of claim 3, wherein the selection component is configurable to operate in a first mode wherein video information from the target input port alone is provided to the output port for output to an external computer, when connected, and a second mode wherein the selection component is configured to combine video information received from the target port and video information received by at least one other of the plurality of input ports and provide composite video information derived therefrom to the output port for output to the external computer when connected.
